(19) United States
(12) Patent Application Publication
(10) Pub. No.: US 2010/0009631 A1
(43) Pub. Date: Jan. 14, 2010

(54) TRANSMITTING ACCESSORY UTILIZING POWER SYSTEM TRANSMISSION

(76) Inventor: Paul P. Griffin, JR., Nashville, TN (US)

Correspondence Address: HORNKOHL INTELLECTUAL PROPERTY LAW, P.L.L.C, P.O. BOX 210584, NASHVILLE, TN, 37221, US

(21) Appl. No.: 12/483,767

(22) Filed: Jun. 12, 2009

Related U.S. Application Data
(60) Provisional application No. 61/060,812, filed on Jun. 12, 2008.

(51) Int. Cl. H04B 7/24; H04B 17/00; H04B 7/00

(52) U.S. Cl. 455/41.2; 455/39; 455/62

(57) ABSTRACT

An accessory for broadcasting audio from a portable electronic device to an automobile stereo receiver has an input/output port that couples the accessory to the device. The accessory receives an audio signal from the device and modulates the audio signal to a broadcast frequency. The modulated signal is coupled to the automobiles electrical system. The wiring in the automobiles electrical system then acts as an antenna that transmits the audio signal to vehicles stereo. Since the automobiles wiring is very close to the stereo antenna, an exceptionally clear, very low transmission can be achieved. The accessory is preferably adapted to be mounted in a 12-volt car outlet and can be configured to automatically identify an open frequency for transmitting the audio signal.

### CROSS-REFERENCES TO RELATED APPLICATIONS

The present application claims priority from co-pending Provisional Patent Application No. 61/060,812 entitled “TRANSMITTING ACCESSORY FOR AUTOMOBILE” filed Jun. 12, 2008.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable CL BACKGROUND OF THE INVENTION

Transmitters for digital music players that allow a user to transmit audio from the device to a remote receiver such as an FM stereo receiver are known in the prior art. While these devices are widely used and popular devices, they suffer from a number of drawbacks. First, transmit power restrictions limit the range of the transmitters. In addition, the location of the antenna of the transmitter is often disadvantageously positioned with respect to the antenna of the receiver. For example, when a transmitter is mounted in the 12-volt outlet of an automobile, the antenna of the transmitter may not have a clear transmission path to the antenna of the car stereo. Larger antennas can be provided to increase the transmission capabilities of the device. Unfortunately, these antennas are bulky and difficult to mount, especially when used in an automobile, which makes these antennas less appealing to consumers. Therefore, what is needed is an improved transmitter for a digital music player that allows audio from the player to be broadcast over the speakers of a car stereo.

### BRIEF SUMMARY OF THE INVENTION

The present invention can be embodied in an accessory for use with a portable electronic device in a vehicle having an electrical system and a wireless stereo receiver. The accessory includes a receiver for receiving a signal from the portable electronic device and a coupler for coupling the signal from the portable electronic device to the electrical system of the vehicle such that the signal can be received by the wireless receiver. The accessory is preferably adapted to couple to the electrical system through a 12-volt car outlet and includes a dock for docking the portable electronic device to the accessory. A modulator in the accessory modulates the received audio signal to a broadcast frequency. The broadcast frequency can be selected by a user or the accessory can automatically identify an open frequency for transmitting the signal to the stereo receivers. The accessory displays the broadcast frequency so that the stereo can be tuned to the selected frequency. The broadcast frequency signal is coupled to the electrical system of the device through an electrical contact in the 12-volt outlet. The accessory also receives power through the 12-volt connection and provides power from the electrical system to the device. Verification software or hardware that verifies the accessory and/or the device is produced by an approved manufacturer.

The present invention can also be embodied in a method of transferring an audio signal from a portable electronic device to a receiver in an automobile. In accordance with the method an open broadcast frequency is selected by a user or is automatically determined. The audio signal is then received from the music player. A broadcast frequency signal is produced based upon the received audio signal. The broadcast frequency signal is coupled to an electrical power system of the automobile through a 12-volt outlet adapter. Power is provided from the electrical power system to the portable electronic device. The method is preferably performed with an accessory that is electrically coupled to the portable electronic device and the electrical power system.

Yet another embodiment of the present invention is directed toward an accessory for use with a digital music player. The accessory has a housing adapted to couple with a 12-volt car outlet and a dock adapted to couple to the music player such that an audio signal from the player can be received by the accessory. An FM transmitter in the accessory receives the audio signal and produces an FM broadcast frequency signal based upon the audio signal. A set of user inputs and a display allow a user to select the frequency for the FM broadcast frequency signal. A conductor electrically couples the broadcast frequency signal to the electrical power system of an automobile through the 12-volt outlet of the automobile. A conductive wire supplies power from the electrical power system to the portable electronic device through the accessory.

The present invention can also be embodied in an accessory for a digital music player that uses a 120-volt power supply connection to a 120-volt power transmission grid to couple an audio signal from the digital music player to the grid for wireless transmission to a remote receivers.

### BRIEF DESCRIPTION OF THE SEVERAL VIEWS OF THE DRAWINGS

FIG. 1 is an illustration of an embodiment of the invention adapted to the mounted in a 12-volt car outlet;

FIG. 2 is an illustration of an alternative embodiment of an accessory constructed in accordance with the present invention;

FIG. 3 is a functional block diagram of an accessory constructed in accordance with an embodiment of the present invention coupled to a portable electronic device;

FIG. 4 is a flow chat of a method of broadcasting audio signal through the wiring of a vehicle in accordance with an embodiment of the invention and

FIG. 5 is an alternative embodiment of the present invention that uses the interior wirings of a house to transmit audio and data from a portable electronic device.

### DETAILED DESCRIPTION OF THE INVENTION

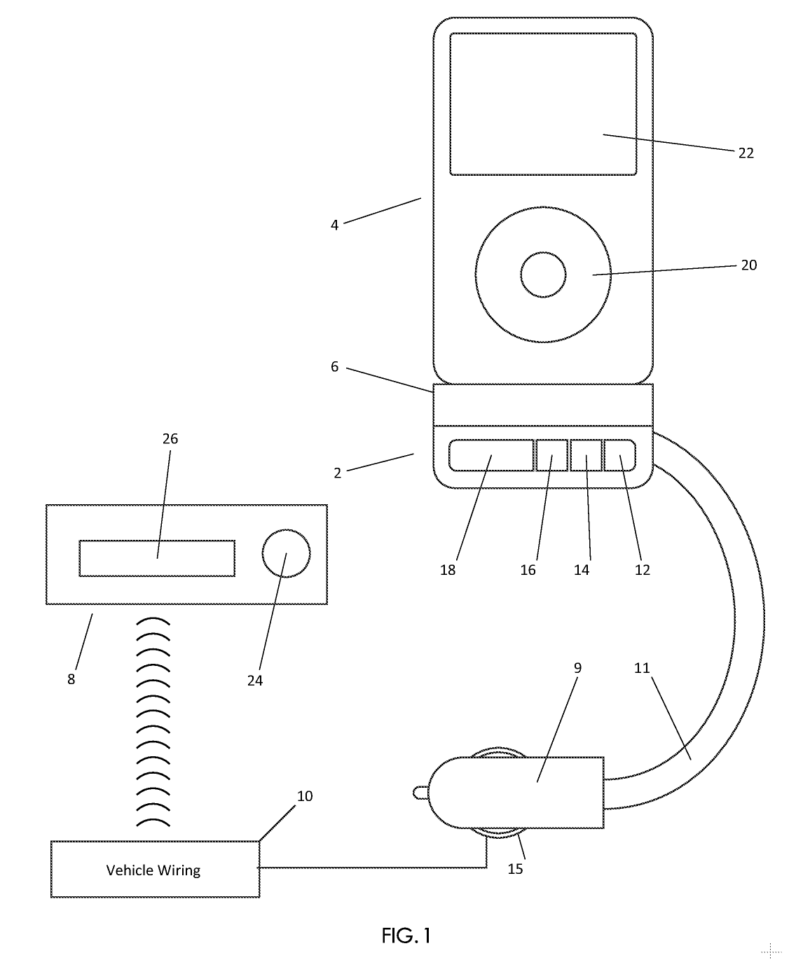

An illustration of an accessory 2 constructed in accordance with an embodiment of the present invention coupled to a portable electronic device 4 is shown in FIG. 1. that is adapted to be mounted in a 12-volt vehicle outlet. The accessory 2 is designed to couple with the portable electronic device 4 through a dock 6 that establishes electrical connections between the device 4 and accessory 2 such that digital or analog audio signals can be transferred between the device 4 and accessory 2. The particular type of connector, USB 30 pin, barrel, etc., that is used to electrically and physically couple the dock 6 of the accessory 2 to the corresponding input/output connector of the device 4 depends upon the type of input/output connector on the device 4 for which the accessory is designed.

Power supplied to the accessory 2 through a 12-volt outlet adapter 9 is supplied to the device 4 through the dock connector 6. A flexible extension 11 arm connects the 12-volt adapter 9 to the upper mounting portion of the dock 6 which can be adjusted such that the displays 18 and 22 of the device and accessory are easily visible and their controls 12, 14, 16 and 2 readily accessible. The dock 6 is also preferably adjustable on two axis with respect to the flexible extension arm 11 such that the portable electronic device 4 and mounted accessory 2 can be turned in a counter clockwise or clockwise manner with respect to a right, left and forward/backward plane. This is accomplished through the use of a ball joint positioned between the dock 6 and the extendible arm 11.

The accessory 2 contains a transmitter that allows audio signals and data received from the device 4 to be transmitted to the automobiles stereo receiver 8 through the vehicle's electrical power wiring 10. User inputs 12, 14 and 16, and a display 18, are preferably provided on the accessory 2 itself that allow a user to select a frequency or channel on which to transmit the data received from the device 4 to the remote receiver 8. The accessory display 18 is preferably an organic light emitting device display (OLED) and the user in puts 12, 14 and 16 soft buttons that can be reprogrammed to perform different functions. An unused channel or frequency is preferably selected by the user for the transmission the accessory 2 and the remote receiver 8 to minimize interference. However, the accessory 2 can also be provided with a receiver and search routine so that the accessory 2 locates the clearest frequency band for the transmission and configures it transmitter to transmit at the located frequency channel.

The output of the transmitter in the accessory 2 is preferably coupled to the vehicle wiring 10 through the power contacts 15 on the 12-volt outlet 9. However, the transmitter can also be capacitively or inductively coupled to the vehicle wiring if desired. The vehicle's wiring 10 then functions as all antenna through which the signal is broadcast to the stereo receiver 8. Since the vehicle wiring 10 typically surrounds the car stereo 8, a lower power, clearer transmission between the transmitting accessory 9 and the stereo 8 is achieved as compared to a traditional antenna positioned in the accessory 2.

The accessory 9 can preferably write text to the portable, electronic device's display 22 and the remote receiver's display 26 and repurpose the controls 20 of the portable electronic device 4 to control functions of the accessory 2 and receiver 8. In such an embodiment, the accessory 2 can digitally instruct the receiver 8 to tune to the frequency or channel selected with the controls 20 of the device 4. The accessory controls 12, 14 and 16 or device controls 20 can also be used to manipulate accessory 2 generated menus displayed on a display screen 18, 22 or 26 of the accessory 2 portable device 4 or receiver 8. By selecting the proper menus and selections, accessory 2, device 4 and receiver 8 functions, such as the volume, operating mode, display, etc. can be controlled by a user through manipulation of the controls of the accessory 2, device 4 or receiver 8. Which particular controls to use to control which particular functions will be determined based upon the particular type of portable electronic device and remote receiver for which the accessory 2 is designed or configured.

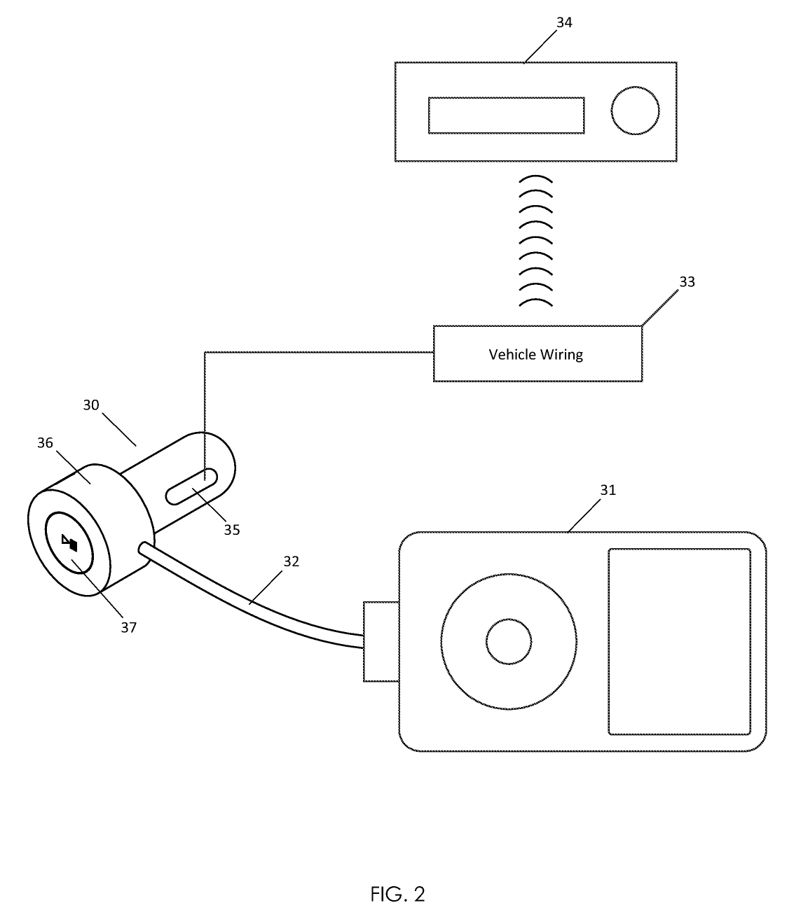

Referring now to FIG. 2, an alternative embodiment of an accessory constructed in accordance with the present invention is shown. Like the embodiment of FIG. 1, the accessory 30 receives an audio output from a portable electronic device 31, modulates the signal to a broadcast frequency and couples the modulated signal to the vehicle's electrical wiring 33. The vehicle's electrical wiring 33 then acts as an antenna to transmit the signal to the vehicle's receiver 34. Unlike the embodiment of FIG. 1, the accessory 30 of FIG. 2 is coupled to the portable electronic device 31 through a cable and connector 32. The transmitter of the accessory 31 is contained within a housing 36 that is adapted to be inserted into the 12-volt outlet of an automobile. The controls 37 for the accessory 30, and the device 31, are positioned on the face of the housing 36. The output of the transmitter is coupled to the vehicle's electrical wiring 33 through an electrical contact 35. The electrical contact 35 also provides power to the accessory 30 which in turn can provide power to the portable device 31 through the cable and connector 32.

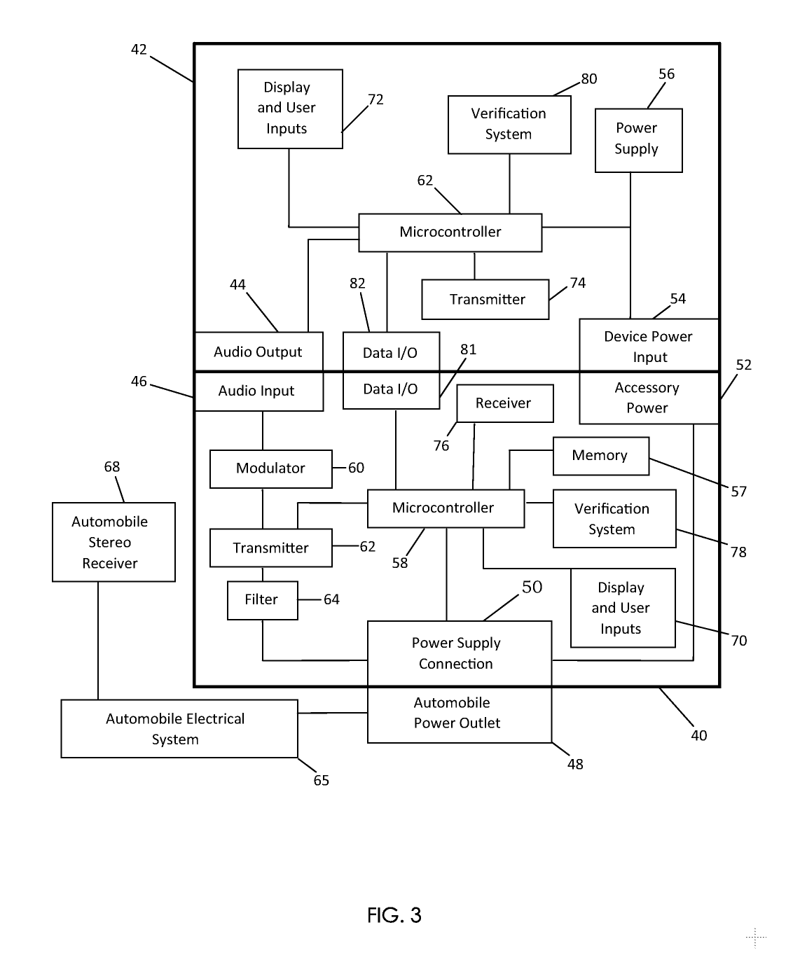

Referring now to FIG. 3, a functional block diagram of an accessory 40 constructed in accordance with an embodiment of the present invention coupled to a portable electronic device 42 is shown. The accessory 40 is electrically connected to an automobile power outlet 48 through a power supply coupler 50. The power supply coupler 50 supplies power to the circuitry of the accessory 40 and an accessory power output 52. The accessory power output 52 is adapted to be coupled to a device power input 54 that allows the device 42 to receive power from the accessory 40 to power its circuitry and charge its power supply 56. Power conversion and conditioning circuitry may be included in the accessory 40 if necessary to provide appropriately conditioned power to the device 42 and accessory 40.

An audio output 44 of the device 42 is coupled to a mating audio input 46 of the accessory 40 such that the accessory can receive audio data in either analog or digital form from the device 42. If an analog audio signal is received from the device 42, the audio is modulated to the selected transmission frequency by a signal modulator 60. The audio signal can also be modulated as a satellite radio signal by the microcontroller 58 such that the output of the transmitter 62 can be received by a satellite radio equipped receiver. The modulated signal is then provided to a transmitter 62 that conditions the signal for transmission and couples the transmission signal to the power supply connection 50 through a filter 64. The filter 64 preferably blocks DC voltages from the power supply connection 50 from entering the transmitter 62. However, depending upon the output characteristics of the transmitter 62, a filter 64 may or may not be required. If the audio data is digital, the data is processed by the microcontroller 58 to produce an analog signal that is coupled to the transmitter 62. The transmitter 62 then couples the analog signal to the accessory power supply connection 50 through the filter 64.

The power supply connection 50 is coupled to the automobile power outlet 48 which is preferably a standard 12-volt outlet. The automobile power outlet 48 is electrically connected to the automobile's electrical system 65. The automobile's electrical system 65 functions as an antenna to transmit the signal coupled from the accessory 40 to the stereo receiver 68 on the selected frequency. This increases the transmission clarity of a typical low power FM transmitter

The various functions of the accessory 40 are controlled by the microcontroller 58. The selected transmission frequency for the accessory is preferably displayed on the display 70 of the accessory 40. The accessory 40 can also preferably send data to the portable electronic device 42 that instructs the portable electronic device to display the currently selected transmitter frequency or channel on thee display screen 72 of the device 42. By utilizing the display 72 of the device 42, the cost of the components required to implement the accessory 40 is minimized. In addition, the accessory 40 can display menus on the display screen 72 of the device 42 and allow a user to manipulate the menus through the use of the controls 72 of the device 42 to configure the accessory 40.

Additional digital data input/output ports 81 and 82 can be provided on the accessory 40 and device 42 to facilitate the transfer of digital data between the accessory and device. The particular ports used will depend upon the available inputs/outputs of the device 42 for which the accessory 40 is designed and the desired functionality of the accessory. In addition, if the device 42 for which the accessory 40 is designed is equipped with a wireless transmitted 14 the accessory 40 can be constructed with a compatible wireless receiver 76 such that the audio data can be transmitted wirelessly from the device 42 to the accessory 40.

A transmitting accessory 40 constructed in accordance with an embodiment of the present invention may also include a verification system that cooperates with a verification system 80 in the device to verify that the accessory 40 is being used by an approved portable electronic device 42 or that the accessory is an approved accessory for the device. The verification systems 78 and 80 can use an identification resistor, a digital certificate, validation code or any other type of identification system or circuitry to verify that the device 42 and accessory 40 are produced by approved entities. Digital rights management software may also be included in memory 57 the accessory 40 to verify the authenticity of any copyrighted material being transmitted from the device 42 to the remote receiver 68 by the accessory 40.

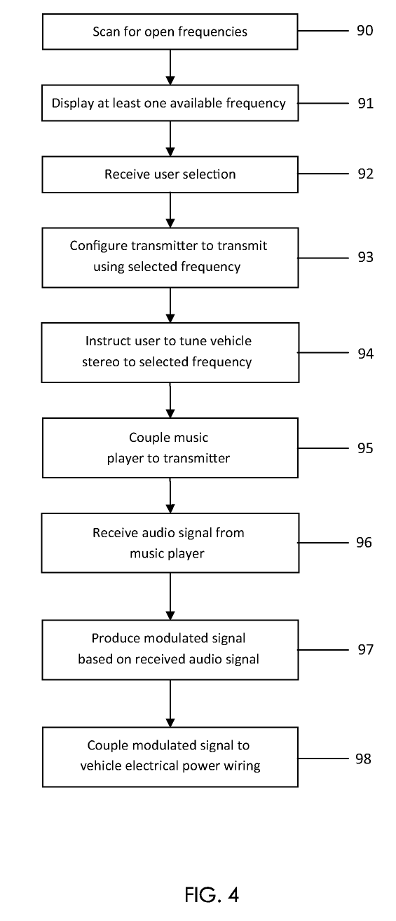

Referring now to FIG. 4, a flow chart of a method of broadcasting an audio signal through the wiring of a vehicle in accordance with the invention is shown. The method begins in step 90 with the scanning of the broadcast spectrum for an open frequency. In step 91, at least one open frequency for the transmission is displaced for selection by a user. In step 92, the user's selection is received. The transmitter is then configured to transmit using the selected frequency in step 93. In step 94, the user is instructed to tune the vehicle's stereo to selected frequency. A music player is coupled to the transmitter in step 95. An audio signal is received from the music player in step 96. A modulated signal based on the received audio signal is produced in step 97. The modulated signal is then coupled to the vehicle's electrical power wiring for broadcast transmission to the vehicle's stereo receiver in step 98. Those skilled in the art will appreciate that the order of some of the steps of the method shown in FIG. 4 can be altered without materially departing from the essence of the invention.

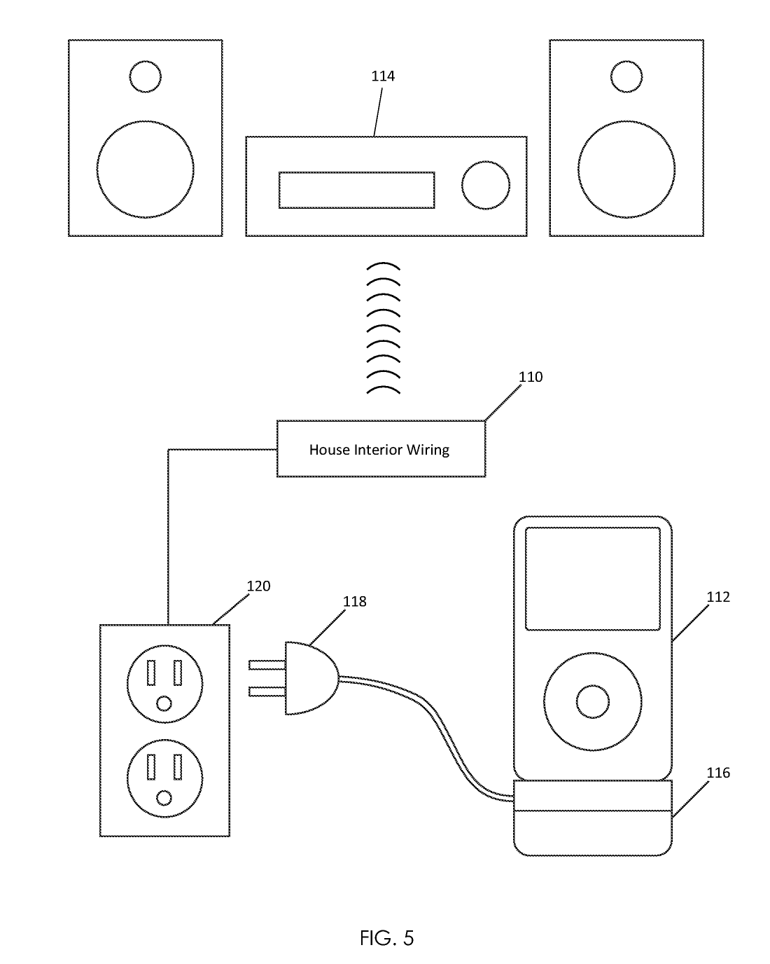

Referring now to FIG. 5, an alternative embodiment of the present invention that uses the interior wiring 110 of a house to transmit audio and data from a portable electronic device 112 to a home stereo system 114. The invention is embodied in a dock 116 that receives and charges to the portable electronic device 112. The dock 116 receives an audio signal from the device 112 and produces a modulated output signal that is coupled the interior wiring 110 through a standard 120-volt plug and cable 118 that is plugged in outlet 120. The interior wiring 110 then broadcast the modulated output signal to the stereo system 114.

Although there have been described particular embodiments of the present invention of a new and useful TRANSMITTING ACCESSORY UTILIZING POWER SYSTEM TRANSMISSION, it is not intended that such references be construed as limitations upon the scope of this invention except as set forth in the following claims.

1. An accessory for coupling with a portable electronic device for use in a vehicle having an electrical system and a wireless receiver, said accessory comprising:
a receiver for receiving a signal from said portable electronic device and a coupler for coupling said signal from said portable electronic device to said electrical system of said vehicle such that said signal can be received by said wireless receiver.

2. The accessory of claim 1 wherein said accessory is adapted to couple to said electrical system through a 12-volt car outlet.

3. The accessory of claim 1 wherein said accessory automatically identifies an open frequency for transmitting said signal to wireless receiver.

4. The accessory of claim 1 wherein said accessory is adapted to provide power from said electrical system to a power supply of said device.

5. The accessory of claim 1 wherein said accessory includes a modulator for modulating said signal to an FM broadcast frequency.

6. The accessory, of claim 5 wherein said accessory displays said FM broadcast frequency.

7. The accessory of claim 5 wherein said broadcast frequency is user selectable.

8. The accessory of claim 1 further comprising a dock for docking said portable electronic device to said accessory.

9. The accessory of claim 1 further comprising verification software or hardware that verifies said accessory or said device is produced by an approved manufacturer.

10. A method of transferring an audio signal from a portable music player to a receiver in an automobile, said method comprising the steps of:
producing a broadcast frequency signal based upon said audio signal; and
coupling said broadcast frequency signal to an electrical power system of said automobile.

11. The method of claim 10 wherein a broadcast frequency of said broadcast frequency signal is selected by a user.

12. The method of claim 10 further comprising the step of providing power from said electrical power system to said portable electronic device.

13. The method of claim 10 wherein said method is performed with an accessory that is electrically coupled to said portable electronic device and said electrical power system.

14. The method of claim 10 wherein said broadcast frequency signal is an FM broadcast frequency signal.

15. The method of claim 10 wherein said broadcast frequency signal is coupled to said electrical power system of said automobile through a 12-volt outlet adapter.

16. The method of claim 10 further comprising the step of determining an open frequency for use as said broadcast frequency.

17. The method of claim 10 further comprising the step of displaying said broadcast frequency.

18. An accessory for use with a portable electronic device, said accessory comprising:
a housing adapted to couple with a 12-volt car outlet;
a dock adapted to couple to said portable electronic device such that audio signal from said portable electronic device can be received by said accessory;
an FM transmitter for receiving said audio signal and producing an FM broadcast frequency signal based upon said audio signal; and
a set of user inputs and a display that allow a user to select an FM broadcast frequency for said FM broadcast frequency signal; and
a conductor for electrically coupling said broadcast frequency signal to a electrical power system of an automobile through a 12-volt outlet of said automobile.

19. The accessory of claim 18 further comprising a conductor for supplying power from said electrical power system to a power supply of said portable electronic device.

20. The accessory of claim 18 wherein said portable electronic device includes a digital music player.
